(19) United States
(12) Patent Application Publication
(10) Pub. No.: US 2013/0321653 A1
(43) Pub. Date: Dec. 5, 2013

(54) INCLINATION RECEIVING APPARATUS AND METHOD, INCLINATION TRANSMITTING APPARATUS AND METHOD, AND INCLINATION COMMUNICATING SYSTEM AND METHOD

(71) Applicant: Takeo Onishi, Tokyo (JP)

(72) Inventor: Takeo Onishi, Tokyo (JP)

(73) Assignee: NEC CORPORATION, Tokyo (JP)

(21) Appl. No.: 14/000,249

(22) PCT Filed: Feb. 9, 2012
(86) PCT No.: PCT/JP2012/053587

§ 371 Date: Aug. 19, 2013

(30) Foreign Application Priority Data
Mar. 1, 2011 (JP) 2011-043870

(51) Int. Cl. H04N 5/232

(52) U.S. Cl. CPC H04N 5/23222
USPC 348/207.1

(57) ABSTRACT

The present invention provides an inclination receiving apparatus that can share the status of inclination of each of a plurality of apparatuses. The inclination receiving apparatus receives inclination information indicating the inclination of another apparatus and reports at least one of a direction and magnitude by which the inclination receiving apparatus should be moved, on the basis of the received inclination information.

### TECHNICAL FIELD

The present invention relates to a technology for sharing a content among a plurality of apparatuses.

### BACKGROUND ART

A technology for sharing a content among a plurality of apparatuses is known.

For example, patent document 1 discloses a technology for displaying a common image on each display screen of a plurality of information communication terminals and reporting information indicating a content shared by a transmission side and a reception side when displaying a mark for indicating a part which is a target of topic in the image.

Further, a technology for controlling a function of a device according to an inclination of the device, is known.

For example, patent document 2 discloses a technology for inhibiting imaging when a portable terminal is inclined by a predetermined unnatural angle.

### Patent Document

[PATENT DOCUMENT 1] Japanese Patent Application Laid-Open No. 2005-244866

[PATENT DOCUMENT 2] Japanese Patent Application Laid-Open No. 2002-290818

### SUMMARY OF THE INVENTION

### Problem to be Solved by the Invention

Communication of information indicating an information processing to the content shared among the apparatuses can be enabled by the technology described in patent document 1. However, in the technology, communication of the information indicating an inclination of the apparatus is not described. Therefore, the sharing a state of the inclination of each apparatus cannot be enabled by using the technology described in patent document 1.

Control of the function of the apparatus according to the inclination of the apparatus can be enabled by the technology described in patent document 2. However, in the technology, transmission of the information indicating an inclination of the apparatus to another apparatus is not described. Therefore, even when the technology described in patent document 2 is applied to the technology by which the content is shared, the sharing a state of the inclination of each apparatus cannot be enabled.

One example of the object of the present invention is to provide an inclination receiving apparatus and method, an inclination transmitting apparatus and a method, and an inclination communicating system and a method by which a state of an inclination of each apparatus can be shared.

### Means for Solving a Problem

An inclination receiving apparatus according to one aspect of the present invention is an inclination receiving apparatus which communicates a content with an inclination transmitting apparatus and the inclination receiving apparatus includes receiving unit which receive inclination information indicating the inclination of the inclination transmitting apparatus and report unit which report at least one of a direction and magnitude by which the inclination receiving apparatus should be moved, on the basis of the inclination information.

An inclination transmitting apparatus according to one aspect of the present invention includes a sensor which detects an inclination of the inclination transmitting apparatus, generation unit which generate inclination information indicating the inclination of the inclination transmitting apparatus based on the inclination, and transmitting unit which transmit the inclination information to the inclination receiving apparatus which reports at least one of a direction and magnitude by which the inclination receiving apparatus should be moved, on the basis of the inclination information.

An inclination communicating system according to one aspect of the present invention includes an inclination transmitting apparatus and an inclination receiving apparatus which communicate a content with each other and a server which establishes a session between the inclination transmitting apparatus and the inclination receiving apparatus, wherein said inclination transmitting apparatus includes a sensor which detects an inclination of said inclination transmitting apparatus, generation unit which generates inclination information based on the inclination detected by said sensor, and transmitting unit which transmits the inclination information generated by said generation unit to said inclination receiving apparatus via said server and said inclination receiving apparatus includes receiving unit which receives said inclination information from said inclination transmitting apparatus via said server and report unit which reports at least one of a direction and magnitude by which said inclination receiving apparatus should be moved, on the basis of said inclination information.

An inclination receiving method according to one aspect of the present invention comprises the steps of: receiving inclination information indicating an inclination of another apparatus and reporting at least one of a direction and magnitude by which an inclination receiving apparatus should be moved, on the basis of the inclination information.

An inclination transmitting method according to one aspect of the present invention comprises the steps of: detecting an inclination of an inclination transmitting apparatus, generating inclination information indicating the inclination of the inclination transmitting apparatus based on the inclination, and reporting at least one of a direction and magnitude by which an inclination receiving apparatus should be moved, on the basis of the inclination information.

An inclination communicating method according to one aspect of the present invention comprises the steps of: detecting an inclination of an inclination transmitting apparatus, generating inclination information indicating the inclination of the inclination transmitting apparatus based on the inclination, and reporting at least one of a direction and magnitude by which an inclination receiving apparatus should be moved, on the basis of the inclination information.

A non-transitory computer-readable recording medium having embodied thereon a n inclination receiving program according to one aspect of the present invention causes a computer to perform a process of communicating a content with another apparatus and receiving inclination information indicating an inclination of the another apparatus and a process of reporting at least one of a direction and magnitude by which an inclination receiving apparatus should be moved, on the basis of the inclination information.

A non-transitory computer-readable recording medium having embodied thereon a n inclination transmitting program according to one aspect of the present invention causes a computer to perform a process of detecting an inclination of an inclination transmitting apparatus including the computer, a process of generating inclination information indicating the inclination of the inclination transmitting apparatus based on the inclination, and a process of reporting at least one of a direction and magnitude by which an inclination receiving apparatus should be moved, on the basis of the inclination information.

An inclination receiving apparatus according to one aspect of the present invention is an inclination receiving apparatus which communicates a content with an inclination transmitting apparatus and the inclination receiving apparatus includes receiving means for receiving inclination information indicating an inclination of said inclination transmitting apparatus and report means for reporting at least one of a direction and magnitude by which said inclination receiving apparatus should be moved, on the basis of said inclination information.

### Effect of the Invention

An example of the effect of the invention is to be able to share a state of an inclination of each apparatus.

### BRIEF DESCRIPTION OF THE DRAWINGS

FIG. 1 is a block diagram showing a configuration of an inclination receiving apparatus according to a first exemplary embodiment.

FIG. 2 is a figure showing one example of inclination information.

FIG. 3 is a figure showing one example of a display image in which a direction and magnitude by which an inclination receiving apparatus should be moved are displayed according to information reported by a report unit.

FIG. 4 is a figure showing one example of a display image in which a magnitude by which an inclination receiving apparatus should be moved is displayed according to information reported by a report unit.

FIG. 5 is a diagram showing a hardware configuration of an inclination receiving apparatus according to a first exemplary embodiment and a peripheral apparatus.

FIG. 6 is a flowchart showing one example of an outline of operation of an inclination receiving apparatus according to a first exemplary embodiment.

FIG. 7 is a block diagram showing a configuration of an inclination receiving apparatus according to a second exemplary embodiment.

FIG. 8 is a flowchart showing one example of an outline of operation of an inclination receiving apparatus according to a second exemplary embodiment.

FIG. 9 is a block diagram showing a configuration of an inclination communicating system according to a third exemplary embodiment.

FIG. 10 is a figure showing one example in which a sensor detects an inclination of an inclination transmitting apparatus based on the gravity acceleration on the inclination transmitting apparatus.

FIG. 11 is a figure showing one example in which a sensor detects an inclination of an inclination transmitting apparatus based on a displacement of the gravity acceleration on the inclination transmitting apparatus in a predetermined time.

FIG. 12 is a figure showing one example in which a sensor specifies an angular velocity of an inclination transmitting apparatus and detects an inclination of an inclination transmitting apparatus based on the angular velocity.

FIG. 13 is a flowchart showing one example of an outline of operation of an inclination communicating system according to a third exemplary embodiment.

FIG. 14 is a block diagram showing a configuration of an inclination communicating system according to a first modification example of a third exemplary embodiment.

### EXEMPLARY EMBODIMENTS FOR CARRYING OUT OF THE INVENTION

An exemplary embodiment for carrying out the present invention will be described in detail with reference to the drawing. Further, in each drawing and each exemplary embodiment described in the specification, the same reference number is used for the elements having the same function.

### First Exemplary Embodiment

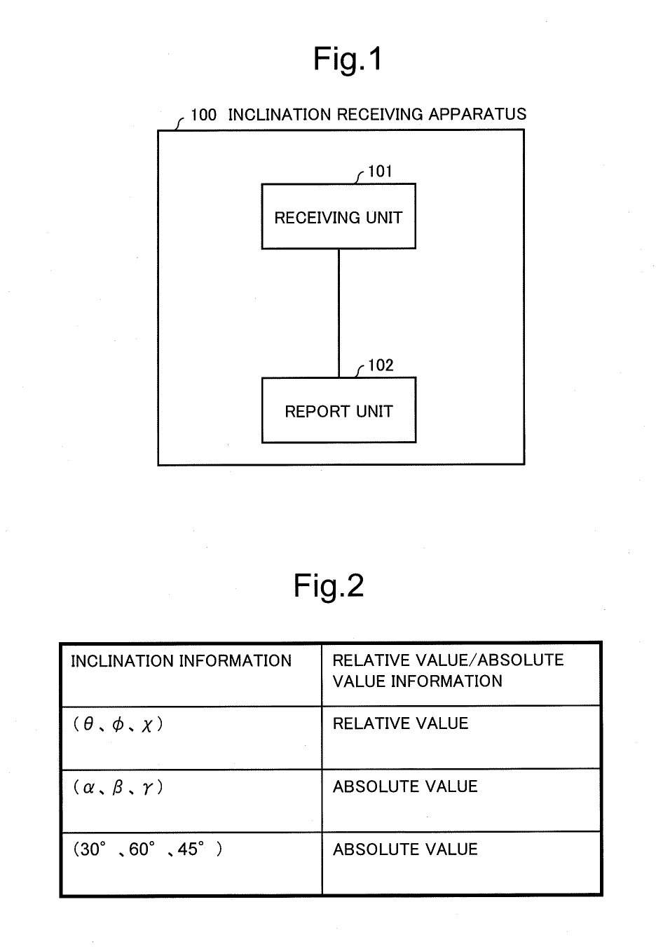

FIG. 1 is a block diagram showing a configuration of an inclination receiving apparatus 100 according to a first exemplary embodiment of the present invention.

Referring to FIG. 1, the inclination receiving apparatus 100 according to the first exemplary embodiment of the present invention includes a receiving unit 101 and a report unit 102.

The inclination receiving apparatus 100 according to the first exemplary embodiment reports at least one of a direction and magnitude by which the inclination receiving apparatus 100 should be moved on the basis of inclination information indicating an inclination of an inclination transmitting apparatus. Therefore, the inclination receiving apparatus 100 can be informed of a state of the inclination of the inclination transmitting apparatus. Namely, the inclination receiving apparatus 100 according to the first exemplary embodiment can share the state of the inclination of the inclination transmitting apparatus between the inclination transmitting apparatus and the inclination receiving apparatus 100.

Each element provided in the inclination receiving apparatus 100 will be described below.

===Receiving Unit 101===

The receiving unit 101 receives inclination information indicating the inclination of the inclination transmitting apparatus (not shown). The inclination information is information indicating the state of the inclination of the inclination transmitting apparatus. The inclination transmitting apparatus generates the inclination information based on information obtained by an acceleration sensor, a gyro sensor (an angular velocity sensor), or the like provided in the inclination transmitting apparatus. For example, the inclination information may include information indicating an angle by which the inclination receiving apparatus 100 has to be inclined that is specified based on the information detected by the acceleration sensor or the gyro sensor of the inclination transmitting apparatus. The inclination may be an acceleration vector or an angular velocity vector of the inclination transmitting apparatus that is specified based on the information detected by the acceleration sensor or the gyro sensor of the inclination transmitting apparatus.

The inclination information may be information indicating an angle between the acceleration vector or the angular velocity vector of the inclination transmitting apparatus that are specified based on the information detected by the acceleration sensor or the gyro sensor and a reference vector indicating a predetermined direction. The reference vector indicating the predetermined direction may be a vector indicating a vertical direction or a specific vector indicating the inclination of the inclination transmitting apparatus at the predetermined time.

FIG. 2 shows one example of the inclination information. Referring to FIG. 2, the inclination information includes information indicating a predetermined angle for each dimension in three dimensions. The inclination information may include information indicating whether each angle included in the inclination information is information (relative value) of displacement or an absolute value based on the direction of the gravity acceleration.

The receiving unit 101 sends the received inclination information to the report unit 102 (described later).

===Report Unit 102===

The report unit 102 receives the inclination information from the receiving unit 101. The report unit 102 reports at least one of the direction and magnitude by which the inclination receiving apparatus 100 should be moved, on the basis of the received inclination information.

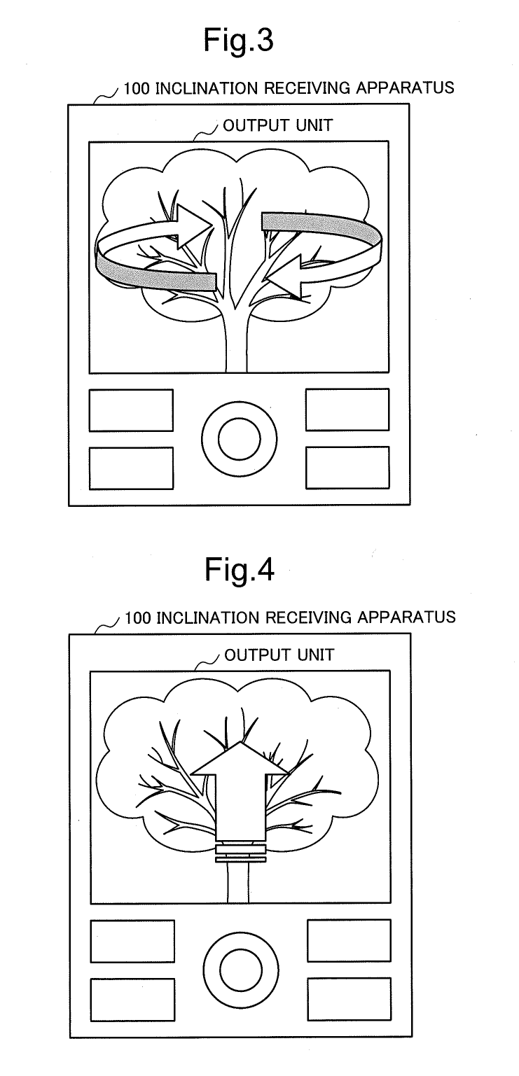

FIG. 3 is a figure showing an example of information of an arrow. The arrow is one aspect of which the report unit 102 reports the direction and magnitude by which the inclination receiving apparatus 100 should be moved. Referring to FIG. 3, the report unit 102 reports the direction in which the inclination receiving apparatus 100 should be moved, by the direction of the arrow displayed in an output unit shown in FIG. 3. The report unit 102 reports the magnitude by which the inclination receiving apparatus 100 should be moved, by a line width of the arrow that is displayed in the output unit shown in FIG. 3.

The report unit 102 specifies the direction of the arrow for report displayed in the output unit shown in FIG. 3 according to the direction indicated by the inclination indicated by the inclination information. The report unit 102 specifies the line width of the arrow for report displayed in the output unit shown in FIG. 3 according to the magnitude (a length of a vector) indicated by the inclination indicated by the inclination information.

The report unit 102 may report the direction and magnitude by which the inclination receiving apparatus 100 should be moved, by using another manner without example as shown in FIG. 3. For example, the report unit 102 may report the direction and magnitude by which the inclination receiving apparatus 100 should be moved, by using a character, a voice, or vibration of a vibrator or the like. The vibration of the vibrator may be a manner which a specific vibration pattern is corresponded to a specific direction. The vibration of the vibrator may be a manner which a plurality of vibrators are used and the vibrator provided in a direction in which the inclination receiving apparatus 100 should be moved vibrates at a vibration level corresponding to the magnitude by which it should be moved.

The report unit 102 may display only the direction in which the inclination receiving apparatus 100 should be moved. In this case, the line width of the displayed arrow shown in FIG. 3 does not relate to the magnitude by which the inclination receiving apparatus 100 should be moved.

The report unit 102 may display only the magnitude by which the inclination receiving apparatus 100 should be moved. In this case, for example, the report unit 102 reports the magnitude by which the inclination receiving apparatus 100 should be moved, by using the line width or the length of the arrow displayed in the output unit as shown in FIG. 4. FIG. 4 shows one example of the information of the arrow. The arrow is one aspect of which the report unit 102 reports the magnitude by which the inclination receiving apparatus 100 should be moved. For example, a report content shown in FIG. 4 indicates that the inclination receiving apparatus 100 is moved closer to an object, in other words, the zooming is performed.

When information showing whether an angle is expressed by a relative value or an absolute value is included in the inclination information, the report unit 102 may perform the following process based on the information.

When it is determined that the information indicating that the angle is expressed by the relative value is included in the inclination information, the report unit 102 reports at least one of the direction and magnitude by which the inclination receiving apparatus 100 should be moved, on the basis of the received inclination information.

On the other hand, when it is determined that the information indicating that the angle is expressed by the absolute value is included in the inclination information, the report unit 102 sends information indicating that the information indicating that the angle is expressed by the absolute value is included in the inclination information to a sensor (not shown). When the sensor (not shown) receives the above-mentioned information, the sensor generates the inclination information based on the information indicating the inclination of the inclination receiving apparatus 100 and sends the generated inclination information to the report unit 102. The report unit 102 reports at least one of the direction and magnitude by which the inclination receiving apparatus 100 should be moved, on the basis of the inclination that is indicated by the sum of the inclination indicated by the inclination information received from the receiving unit 101 and the inclination indicated by the inclination information received from the sensor (not shown).

When it is detected that the inclination receiving apparatus 100 is moved in the direction and magnitude by which the inclination receiving apparatus 100 should be moved, the report unit 102 may report information indicating the completion of the predetermined movement to a user of the inclination receiving apparatus 100. For example, when it is detected that the inclination receiving apparatus 100 is moved in the direction and magnitude by which the inclination receiving apparatus 100 should be moved, the report unit 102 may report information indicating the completion of the predetermined movement to the user of the inclination receiving apparatus 100 as described below. Namely, the report unit 102 may report information indicating the completion of the predetermined movement to the user of the inclination receiving apparatus 100 by generating a specific vibration pattern by the vibrator.

For example, the receiving unit 101 and the report unit 102 are realized by a CPU (Central Processing Unit) which is operated by a program (inclination communications program).

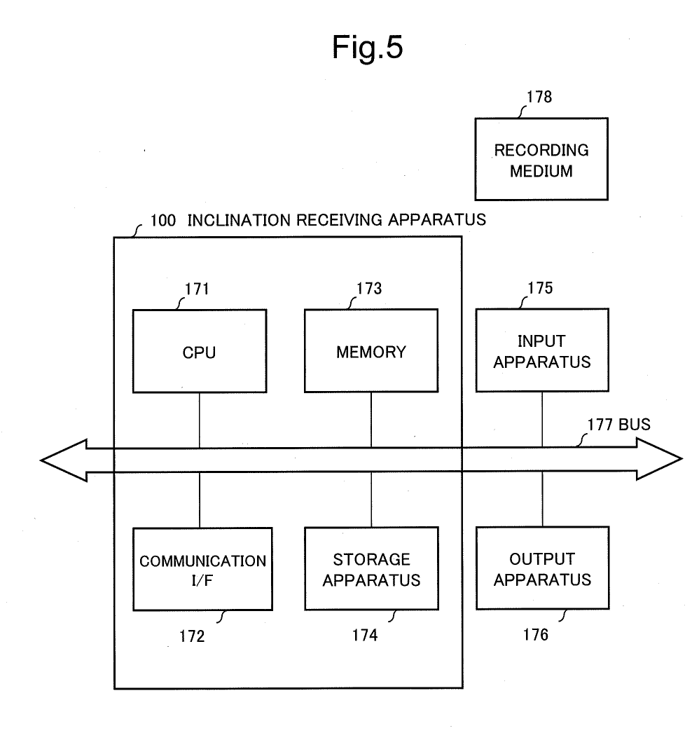

FIG. 5 is a diagram showing a hardware configuration of the inclination receiving apparatus 100 according to the first exemplary embodiment of the present invention and a peripheral apparatus. As shown in FIG. 5, the inclination receiving apparatus 100 includes a CPU 171, a communication I/F 172 (interface 172) for network connection, a memory 173, and a storage apparatus 174 such as a hard disk for storing a program or the like. The inclination receiving apparatus 100 is connected to an input apparatus 175 and an output apparatus 176 via a bus 177.

The CPU 171 operates an operating system and controls the entire inclination receiving apparatus 100 according to this exemplary embodiment. For example, the CPU 171 reads a program or data from a recording medium 178 mounted on a drive apparatus or the like in the memory 173, and executes various processes according to it as the receiving unit 101 and the report unit 102 according to the first exemplary embodiment.

The storage apparatus 174 is for example, an optical disk, a flexible disk, a magnetic optical disk, an external hard disk, a semiconductor memory, or the like and records a computer program for computer-readable. Further, the computer program may be downloaded from an external computer (not shown) connected to a communication network.

An input apparatus 175 is realized by for example, a mouse, a keyboard, a built-in key/button, and the like and used for input operation. Not only the mouse, the keyboard, and the built-in key/button but also for example, a touch panel, an accelerometer, a gyro sensor, or the like can be used for the input apparatus 175. An imaging unit which can generates a content for example, a camera or the like can be used as the input apparatus 175.

The output apparatus 176 is realized by for example, a display and used for checking the output.

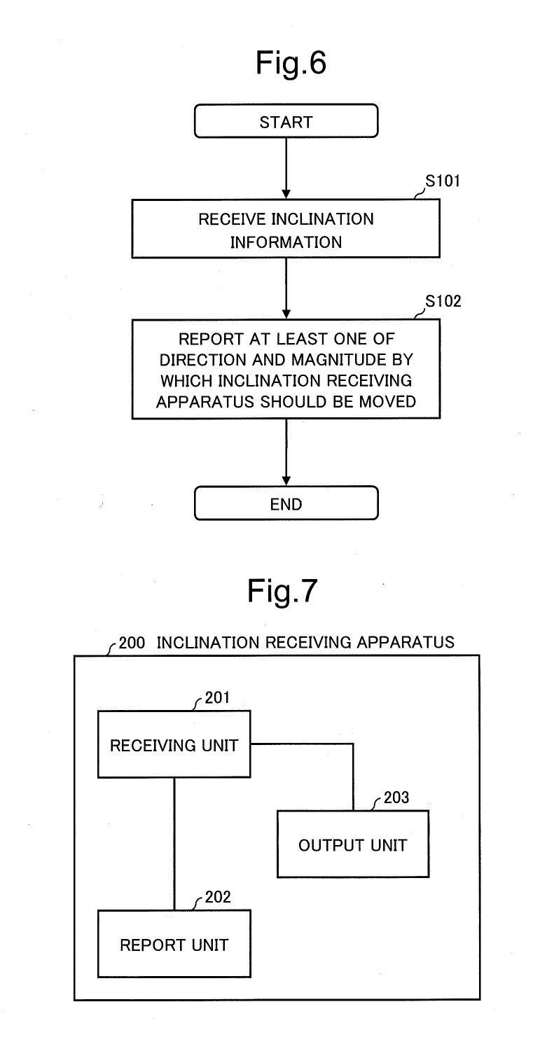

Further, the block diagram (FIG. 1) used for explaining the first exemplary embodiment is a functional block diagram and it does not show a hardware unit configuration. These functional blocks are realized by a hardware configuration shown in FIG. 6. However, means for realizing each unit provided in the inclination receiving apparatus 100 are not limited in particular. Namely, the inclination receiving apparatus 100 may be realized by one apparatus that is physically combined or may be realized by two or more apparatuses that are physically separated from each other and connected with each other by a wired line or a wireless line.

Further, the CPU 171 may read the computer program recorded in the storage apparatus 174 and operate as the receiving unit 101 and the report unit 102 according to the program.

Further, the recording medium (or the storage medium) storing a code of the above-mentioned program is supplied to the inclination receiving apparatus 100 and the inclination receiving apparatus 100 may read the code of the program stored in the recording medium and perform. Namely, the present invention also includes the recording medium 178 which temporarily stores software (information processing program) executed by the inclination receiving apparatus 100 according to the first exemplary embodiment or non-temporarily stores it. The recording medium storing non-temporarily is called a non-volatile storage medium.

FIG. 6 is a flowchart showing one example of an outline of operation of the inclination receiving apparatus 100 according to the first exemplary embodiment of the present invention.

The receiving unit 101 receives the inclination information indicating the inclination of the inclination transmitting apparatus (not shown) (step S101). The report unit 102 receives the inclination information from the receiving unit 101. The report unit 102 reports at least one of the direction and magnitude by which the inclination receiving apparatus 100 should be moved, on the basis of the received inclination information (step S102).

The inclination receiving apparatus 100 according to the first exemplary embodiment reports at least one of the direction and magnitude by which the inclination receiving apparatus 100 should be moved, on the basis of the inclination information indicating the inclination of the inclination transmitting apparatus. Therefore, the inclination receiving apparatus 100 can be informed of a state of the inclination of the inclination transmitting apparatus. Namely, the inclination receiving apparatus 100 according to the first exemplary embodiment can share the state of the inclination of the inclination transmitting apparatus between the inclination transmitting apparatus and the inclination receiving apparatus 100.

For example, when the direction or magnitude by which the inclination receiving apparatus 100 should be moved is indicated by the inclination of the inclination transmitting apparatus, the inclination transmitting apparatus transmits the inclination information indicating the inclination of the apparatus to the inclination receiving apparatus 100. When the inclination receiving apparatus 100 receives this inclination information, it can report at least one of the direction and magnitude by which the inclination receiving apparatus 100 should be moved.

With respect to a technology of sharing the content, the inclination transmitting apparatus and the inclination receiving apparatus 100 output the common content. Here, it is assumed that the inclination receiving apparatus 100 transmits the content generated by a camera connected to the inclination receiving apparatus 100, a built-in camera of the inclination receiving apparatus 100, or the like to the inclination transmitting apparatus. Further, it is assumed that the inclination receiving apparatus 100 shares the generated content with the inclination transmitting apparatus.

The user of the inclination transmitting apparatus views the content outputted from the output unit provided in the inclination transmitting apparatus. The user specifies a spot that the user wants to be displayed by the inclination receiving apparatus 100 based on the content viewed by the user. For example, it is assumed that the user wants to be displayed a part displayed at the edge of the output unit in the content currently displayed in the output unit at the center of the output unit or the user wants to be displayed a part that is not currently displayed in the output unit in the output unit. At that time, as if the inclination transmitting apparatus generates the content, the user inclines the inclination transmitting apparatus so that the specified spot is included in an imaging range of the camera connected to the inclination transmitting apparatus or the built-in camera of the inclination transmitting apparatus. At that time, the generated inclination information is transmitted to the inclination receiving apparatus 100.

The inclination receiving apparatus 100 reports at least one of the direction and magnitude by which the inclination receiving apparatus 100 should be moved, on the basis of the received inclination information. For example, the inclination receiving apparatus 100 may report so as to be equal to the inclination of the inclination receiving apparatus 100 when the inclination receiving apparatus 100 takes the image in which the spot at which the user of the inclination transmitting apparatus wants to be displayed by the inclination receiving apparatus 100 is as the center. As a result, the inclination receiving apparatus 100 can properly take an image of the position which the user of the inclination transmitting apparatus wants to be displayed by the inclination receiving apparatus 100. The user of the inclination transmitting apparatus can easily specify the spot which the user of the inclination transmitting apparatus wants to be displayed by the inclination receiving apparatus 100 even when the spot is not imaged by the camera of the inclination receiving apparatus 100 or the like. Further, the user of the inclination transmitting apparatus can specify the spot which the user of the inclination transmitting apparatus wants to be displayed by the inclination receiving apparatus 100 by only inclining the apparatus and the user can easily operate by one hand.

As another example, it is assumed that the inclination transmitting apparatus transmits the content generated by the camera connected to the inclination transmitting apparatus or the built-in camera of the inclination transmitting apparatus to the inclination receiving apparatus 100. Further, it is assumed that the inclination transmitting apparatus shares the content with the inclination receiving apparatus 100. In this case, the inclination transmitting apparatus generates the inclination information based on the inclination when the content is generated and transmits the inclination information to the inclination receiving apparatus 100. For example, when the inclination transmitting apparatus shares the content taken by the camera connected to it or the built-in camera of it with the inclination receiving apparatus 100, the inclination information is generated based on the inclination of the inclination transmitting apparatus at the time of imaging.

The inclination receiving apparatus 100 receives the inclination information and reports at least one of the direction and magnitude by which the inclination receiving apparatus 100 should be moved, on the basis of the inclination information. For example, the inclination receiving apparatus 100 may report so as to be equal to the inclination of the apparatus when the inclination transmitting apparatus generates the content (takes the image by the camera). As a result, the inclination receiving apparatus 100 can re-create the state of the inclination of the inclination transmitting apparatus when the inclination transmitting apparatus generates the content in the inclination receiving apparatus 100. Namely, the user of the inclination receiving apparatus 100 can view the content with reality.

### Second Exemplary Embodiment

FIG. 7 is a block diagram showing a configuration of an inclination receiving apparatus 200 according to a second exemplary embodiment. Referring to FIG. 7, the inclination receiving apparatus 200 according to the second exemplary embodiment includes a receiving unit 201, a report unit 202, and an output unit 203.

The inclination receiving apparatus 200 according to the second exemplary embodiment different from the inclination receiving apparatus 100 according to the first exemplary embodiment in a point to receives information indicating an aspect ratio of a content. This is a difference between the inclination receiving apparatus 200 and the inclination receiving apparatus 100. In the second exemplary embodiment, it is assumed that the content has a specific length in vertical and horizontal directions like an image, a moving image, or the like.

===Output Unit 203===

When the output unit 203 receives the content from the receiving unit 201 (described later), the output unit 203 outputs the content.

===Receiving Unit 201===

The receiving unit 201 receives the inclination information indicating the inclination of the inclination transmitting apparatus (not shown). Further, the receiving unit 201 receives the content from the inclination transmitting apparatus (not shown). Further, the receiving unit 201 receives the information indicating the above-mentioned aspect ratio of the content.

===Report Unit 202===

The report unit 202 reports at least one of the direction and magnitude by which the inclination receiving apparatus 100 should be moved, on the basis of the aspect ratio of the content received by the receiving unit 201 in addition to the function provided in the report unit 102.

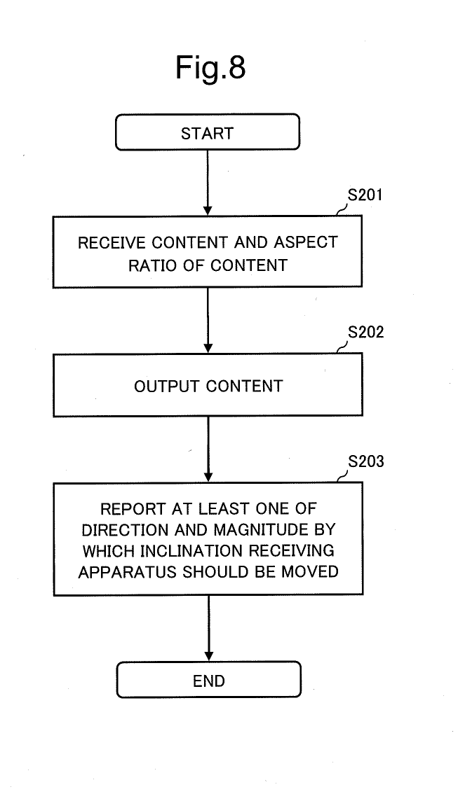

FIG. 8 is a flowchart showing one example of an outline of operation of the inclination receiving apparatus 200 according to the second exemplary embodiment of the present invention.

The receiving unit 201 receives the content and information indicating the aspect ratio of the content from the inclination transmitting apparatus (not shown) (step S201). The report unit 202 receives the information indicating the aspect ratio of the content from the receiving unit 201. Further, the output unit 203 outputs the content received by the receiving unit 201 (step S202). When the output unit 203 outputs the content, the report unit 202 reports at least one of the direction and magnitude by which the inclination receiving apparatus 200 should be moved, on the basis of the received information indicating the aspect ratio of the content (step S203).

When it takes a long time to output the content, the inclination receiving apparatus 200 according to the second exemplary embodiment can report at least one of the direction and magnitude by which the inclination receiving apparatus 200 should be moved during this time. As a result, when the content is outputted, the inclination receiving apparatus 200 can output the content while keeping the apparatus in suitable direction.

For example, when the information indicating the aspect ratio is information which shows that the image is a portrait image, the inclination receiving apparatus 200 reports at least one of the direction and magnitude by which the inclination receiving apparatus 200 should be moved so that the display of the output unit 203 is set to vertically long. As a result, the inclination receiving apparatus 200 can prompt the user to move the inclination receiving apparatus 200 so that the function of the output unit 203 can be maximally utilized.

### Third Exemplary Embodiment

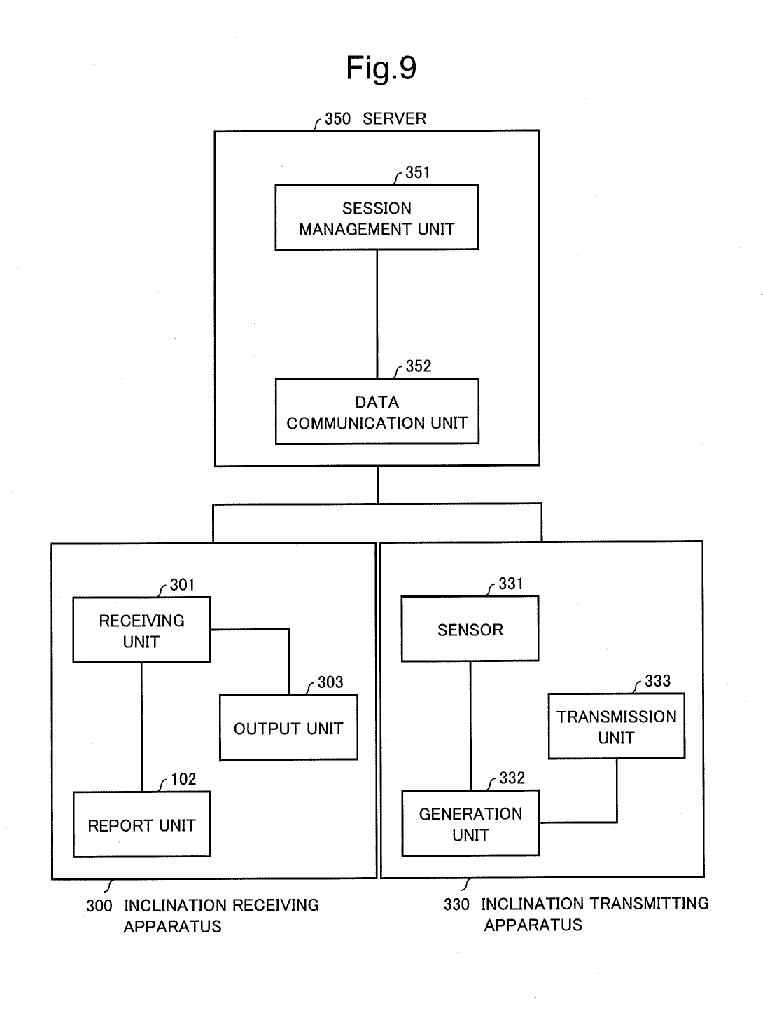

FIG. 9 is a block diagram showing a configuration of an inclination communicating system 30 according to a third exemplary embodiment. Referring to FIG. 9, the inclination communicating system 30 according to the third exemplary embodiment includes an inclination receiving apparatus 300, an inclination transmitting apparatus 330, and a server 350.

<Inclination Receiving Apparatus 300>

The inclination receiving apparatus 300 includes a receiving unit 301, the report unit 102, and an output unit 303. The report unit 102 is the same as that used for the first exemplary embodiment.

===Receiving Unit 301===

The receiving unit 301 receives the inclination information indicating the inclination of the inclination transmitting apparatus 330 from an inclination transmitting apparatus 330. Further, the receiving unit 301 receives the content from the inclination transmitting apparatus 330.

===Output Unit 303===

When the output unit 303 receives the content from the receiving unit 301, the output unit 303 outputs the content. The output unit 303 outputs the content generated by the inclination receiving apparatus 300.

<Inclination Transmitting Apparatus 330>

The inclination transmitting apparatus 330 includes a sensor 331, a generation unit 332, and a transmission unit 333.

===Sensor 331===

The sensor 331 detects the inclination of the inclination transmitting apparatus 330. For example, the sensor 331 is realized by an acceleration sensor, a gyro sensor (angular velocity sensor), or the like. The sensor 331 sends the detected inclination to the generation unit 332 (described later).

For example, the sensor 331 specifies the gravity acceleration on the inclination transmitting apparatus 330 and detects the inclination of the inclination transmitting apparatus 330 based on the gravity acceleration. Further, the sensor 331 specifies a displacement of the gravity acceleration on the inclination transmitting apparatus 330 in a predetermined time and detects the inclination of the inclination transmitting apparatus 330 based on the displacement.

Further, for example, the sensor 331 specifies the angular velocity of the inclination transmitting apparatus 330 and detects the inclination of the inclination transmitting apparatus 330 based on the angular velocity.

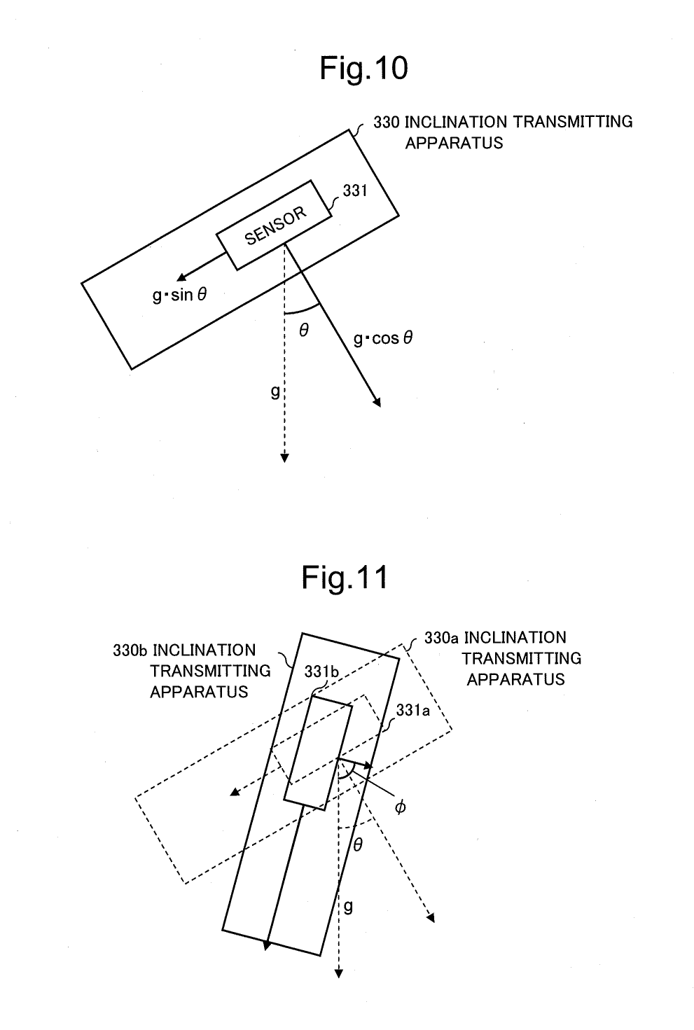

FIG. 10 shows one example in which the sensor 331 detects the inclination of the inclination transmitting apparatus 330 based on the gravity acceleration on the inclination transmitting apparatus 330. For ease of explanation, in FIG. 10, a case in which one-dimensional inclination is detected is shown.

For example, the sensor 331 detects an acceleration represented by ‘g*sin θ’ shown in FIG. 10 and detects an inclination ‘θ’ of the inclination transmitting apparatus 330 based on this acceleration. Where, in FIG. 10, g is the gravity acceleration. Of course, the sensor 331 may detect the inclination for each dimension of three dimensions by using the above-mentioned method.

FIG. 11 is a figure which shows one example in which the sensor 331 detects the inclination of the inclination transmitting apparatus 330 based on the displacement of the gravity acceleration on the inclination transmitting apparatus 330 in a predetermined time. For ease of explanation, in FIG. 11, a case in which one-dimensional inclination is detected is shown.

In FIG. 11, it is assumed that the inclination transmitting apparatus 330 and the sensor 331 at a start time of the predetermined time are shown as an inclination transmitting apparatus 330a and a sensor 331a, respectively. Further, it is assumed that the inclination transmitting apparatus 330 and the sensor 331 at an end time of the predetermined time are shown as an inclination transmitting apparatus 330b and a sensor 331b, respectively. For example, the sensor 331 detects an acceleration represented by ‘g*sin θ’ at the position of the inclination transmitting apparatus 330a shown in FIG. 11 and detects the inclination ‘θ’ of the inclination transmitting apparatus 330a based on this acceleration. Where, in FIG. 11, g is the gravity acceleration. Next, the sensor 331 detects an acceleration represented by ‘g*sin φ’ at the position of the inclination transmitting apparatus 330b shown in FIG. 11 and detects an inclination ‘φ’ of the inclination transmitting apparatus 330b based on this acceleration. The sensor 331 detects the inclination ‘φ−θ’ of the inclination transmitting apparatus 330 based on the detected inclinations θ and φ. Of course, the sensor 331 may detect the inclination for each dimension of three dimensions by using the above-mentioned method.

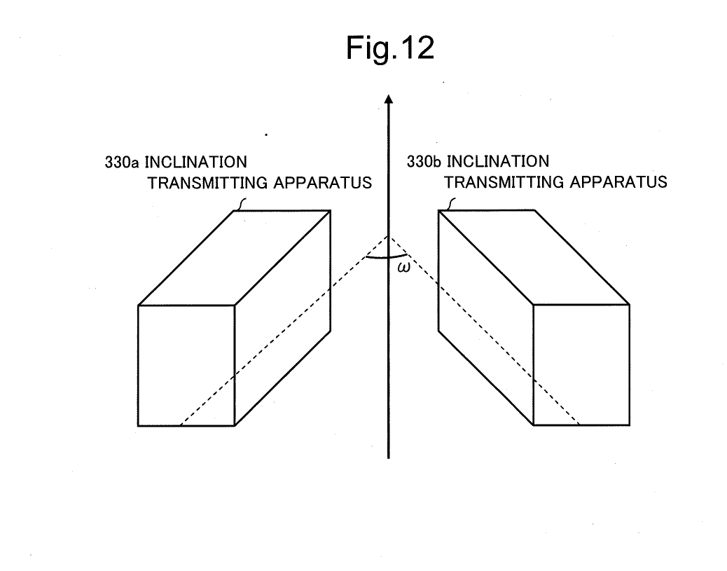

FIG. 12 is a figure which shows one example in which the sensor 331 specifies the angular velocity of the inclination transmitting apparatus 330 and detects the inclination of the inclination transmitting apparatus 330 based on the angular velocity. For ease of explanation, in FIG. 12, a case in which one-dimensional inclination is detected is shown.

For example, the sensor 331 detects an angular velocity ‘ω’ when the inclination transmitting apparatus is moved from the position shown as the inclination transmitting apparatus 330a to the position shown as the inclination transmitting apparatus 330b as shown in FIG. 12 and detects the inclination of the inclination transmitting apparatus 330 based on this angular velocity and a time spent on the movement. Of course, the sensor 331 may detect the inclination for each dimension of three dimensions by using the above-mentioned method.

===Generation Unit 332===

The generation unit 332 receives information of the inclination from the sensor 331. Then the generation unit 332 generates the inclination information based on the received information of the inclination.

===Transmission Unit 333===

The transmission unit 333 receives the inclination information from the generation unit 332. Then the transmission unit 333 transmits the received inclination information to the inclination receiving apparatus 300. When the transmission unit 333 transmits the inclination information to the inclination receiving apparatus 300, the transmission unit 333 may transmit it via the server 350.

<Server 350>

The server 350 includes a session management unit 351 and a data communication unit 352.

===Session Management Unit 351===

The session management unit 351 manages a session between the inclination receiving apparatus 300 and the inclination transmitting apparatus 330. When the session between the inclination receiving apparatus 300 and the inclination transmitting apparatus 330 is started, a communication route through which communication of the content and the inclination information can be performed is established.

===Data Communication Unit 352===

The data communication unit 352 relays the information such as the content, the inclination information, and the like that are communicated between the inclination receiving apparatus 300 and the inclination transmitting apparatus 330.

The server 350 may include a content storage unit (not shown) for storing the content communicated between the inclination receiving apparatus 300 and the inclination transmitting apparatus 330. The content may be communicated between the inclination receiving apparatus 300 and the inclination transmitting apparatus 330 via the content storage unit of the server 350.

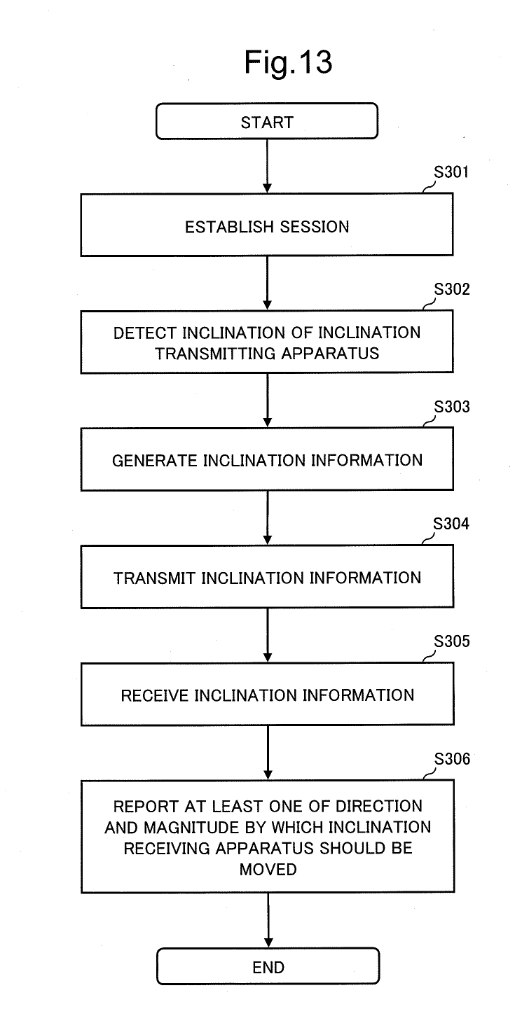

FIG. 13 is a flowchart showing one example of an outline of operation of the inclination communicating system 30 according to the third exemplary embodiment of the present invention.

The server 350 establishes the session between the inclination receiving apparatus 300 and the inclination transmitting apparatus 330 (step S301).

The sensor 331 of the inclination transmitting apparatus 330 detects the inclination of the apparatus (step S302). Then the generation unit 332 generates the inclination information based on the inclination of the apparatus (step S303). Then the transmission unit 333 of the inclination transmitting apparatus 330 transmits the inclination information to the inclination receiving apparatus 300 via the server 350 (step S304).

The receiving unit 301 of the inclination receiving apparatus 300 receives the inclination information (step S305). The report unit 102 receives the inclination information from the receiving unit 301. Then the report unit 102 reports at least one of the direction and magnitude by which the inclination receiving apparatus 300 should be moved, on the basis of the received inclination information (step S306).

In the inclination communicating system 30 according to the third exemplary embodiment, the inclination transmitting apparatus 330 transmits the inclination information indicating the inclination of the inclination transmitting apparatus 330 and the inclination receiving apparatus 300 receives the inclination information. Accordingly, in the inclination communicating system 30, the information about the inclination of the inclination transmitting apparatus 330 can be shared.

For example, it is assumed that the content generated by the inclination receiving apparatus 300 is shared between the inclination transmitting apparatus 330 and the inclination receiving apparatus 300. And it is assumed that a user of the inclination transmitting apparatus 330 wants the inclination receiving apparatus 300 moved so that a location that is not currently taken by the camera provided in the inclination receiving apparatus 300 is displayed in the output unit 303 of the inclination transmitting apparatus 330. In this case, there is an advantage in which it is enough for the inclination transmitting apparatus 330 to transmit only the inclination information indicating the inclination of the inclination transmitting apparatus 330 itself as the information indicating a request for moving the inclination receiving apparatus 300 in a predetermined direction. By this advantage, an advantage in which it is not necessary for the user to perform a special operation other than the operation to incline the apparatus to the inclination transmitting apparatus 330 is further obtained. Namely, the inclination transmitting apparatus 330 according to the third exemplary embodiment has an advantage in which it can be easily operated by one hand of the user and can be easily held by the user's hand even when operating the inclination transmitting apparatus 330.

It is assumed that the content generated by the camera or the like provided in the inclination transmitting apparatus 330 is shared between the inclination transmitting apparatus 330 and the inclination receiving apparatus 300. And it is assumed that the user of the inclination transmitting apparatus 330 wants the inclination receiving apparatus 300 moved so that the inclination of the inclination receiving apparatus 300 is equal to that of the inclination transmitting apparatus 330 when the content is generated. In this case, it is enough for the inclination transmitting apparatus 330 to transmit only the information indicating the inclination of the inclination transmitting apparatus 330 itself as an instruction indicating a request for moving the inclination receiving apparatus 300 in the predetermined direction.

Further, the inclination receiving apparatus 300 according to the third exemplary embodiment has the same advantage as the inclination receiving apparatus 100 according to the first exemplary embodiment.

### First Modification Example of the Third Exemplary Embodiment

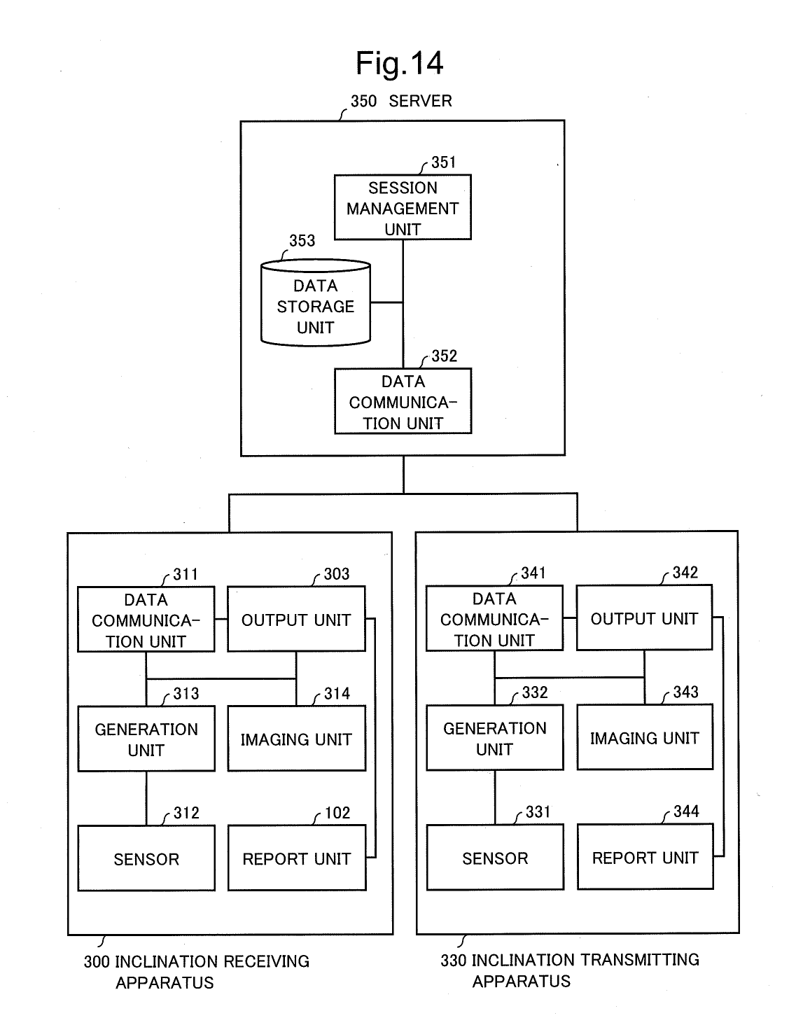

FIG. 14 is a block diagram showing a configuration of the inclination communicating system 30 according to a first modification example of the third exemplary embodiment of the present invention. Referring to FIG. 14, the inclination communicating system 30 according to the first modification example of the third exemplary embodiment includes the inclination receiving apparatus 300, the inclination transmitting apparatus 330, and the server 350. The first modification example of the third exemplary embodiment is one specific example of the third exemplary embodiment.

<Inclination Receiving Apparatus 300>

The inclination receiving apparatus 300 includes the report unit 102, the output unit 303, a data communication unit 311, a sensor 312, a generation unit 313, and an imaging unit 314. The report unit 102 is the same as the report unit 102 used for the first exemplary embodiment. The output unit 303 is the same as the output unit 303 used for the third exemplary embodiment.

===Data Communication Unit 311===

The data communication unit 311 transmits the data (content) taken by the imaging unit 314 (described later) to the inclination transmitting apparatus 330 via the server 350. Further, the data communication unit 311 transmits the inclination information generated by the generation unit 313 (described later) to the inclination transmitting apparatus 330 via the server 350.

The data communication unit 311 receives the inclination information indicating the inclination of the inclination transmitting apparatus 330 from the inclination transmitting apparatus 330 via the server 350. Further, the data communication unit 311 receives the content from the inclination transmitting apparatus 330 via the server 350.

===Sensor 312===

The sensor 312 detects the inclination of the inclination receiving apparatus 300. For example, the sensor 312 is realized by an acceleration sensor, a gyro sensor (angular velocity sensor), or the like. The sensor 312 sends the detected inclination to the generation unit 313 (described later).

For example, the sensor 312 specifies the gravity acceleration on the inclination receiving apparatus 300 and detects the inclination of the inclination receiving apparatus 300 based on the gravity acceleration. Alternatively, the sensor 312 specifies a displacement of the gravity acceleration on the inclination receiving apparatus 300 in a predetermined time and detects the inclination of the inclination receiving apparatus 300 based on the displacement.

Further, for example, the sensor 312 specifies the angular velocity of the inclination receiving apparatus 300 and detects the inclination of the inclination receiving apparatus 300 based on the angular velocity.

A specific method in which the sensor 312 detects the inclination of the inclination receiving apparatus 300 is the same as the method in which the sensor 331 detects the inclination of the inclination transmitting apparatus 330.

===Generation Unit 313===

The generation unit 313 receives information of the inclination from the sensor 312. Then the generation unit 313 generates the inclination information based on the received information of the inclination.

===Imaging Unit 314===

The imaging unit 314 takes an image or a moving image. The imaging unit 314 is realized by for example, a camera.

<Inclination Transmitting Apparatus 330>

The inclination transmitting apparatus 330 includes the sensor 331, the generation unit 332, a data communication unit 341, an output unit 342, an imaging unit 343, and a report unit 344. The sensor 331 is the same as the sensor 331 used for the third exemplary embodiment. The generation unit 332 is the same as the generation unit 332 used for the third exemplary embodiment.

===Data Communication Unit 341===

The data communication unit 341 transmits the data (content) taken by the imaging unit 343 (described later) to the inclination receiving apparatus 300 via the server 350. Further, the data communication unit 341 transmits the inclination information generated by the generation unit 332 to the inclination receiving apparatus 300 via the server 350.

The data communication unit 341 receives the inclination information indicating the inclination of the inclination receiving apparatuses 300 from the inclination receiving apparatus 300 via the server 350. Further, the data communication unit 341 receives the content from the inclination receiving apparatus 300 via the server 350.

===Output Unit 342===

When the output unit 342 receives the content from the data communication unit 341, the output unit 342 outputs the content. Further, the output unit 342 outputs the content generated by the inclination transmitting apparatus 330.

===Imaging Unit 343===

The imaging unit 343 takes an image or a moving image. The imaging unit 343 is realized by for example, a camera.

===Report Unit 344===

The report unit 344 receives the inclination information from the data communication unit 341. The report unit 344 reports at least one of the direction and magnitude by which the inclination transmitting apparatus 330 should be moved, on the basis of the received inclination information.

<Server 350>

The server 350 includes the session management unit 351, the data communication unit 352, and a content storage unit 353. The session management unit 351 is the same as the session management unit 351 used for the third exemplary embodiment. The data communication unit 352 is the same as the data communication unit 352 used for the third exemplary embodiment.

===Content Storage Unit 353===

The content storage unit 353 stores the content communicated between the inclination receiving apparatus 300 and the inclination transmitting apparatus 330. The content is communicated between the inclination receiving apparatus 300 and the inclination transmitting apparatus 330 via the data communication unit 352 and the content storage unit 353 of the server 350.

The inclination communicating system 30 according to the first modification example of the third exemplary embodiment has the same advantage as the inclination communicating system 30 according to the third exemplary embodiment.

As described above, the state of the inclination of each apparatus can be shared. This is one example of the effect of the present invention.

### Fourth Exemplary Embodiment

A first recording medium according to a fourth exemplary embodiment of the present invention records an inclination receiving program which causes a computer to perform a process of communicating a content with another apparatus and receiving inclination information indicating an inclination of the another apparatus. Further, the first recording medium records the inclination receiving program which causes the compute to perform a process of reporting at least one of a direction and magnitude by which an inclination receiving apparatus should be moved, on the basis of the inclination information.

### Fifth Exemplary Embodiment

A second recording medium according to a fifth exemplary embodiment of the present invention records an inclination transmitting program which causes a computer to perform a process of detecting an inclination of an inclination transmitting apparatus including the computer. Further, the second recording medium records the inclination transmitting program which causes the computer to perform a process of generating inclination information indicating the inclination of the inclination transmitting apparatus based on the inclination. Further, the second recording medium records the inclination transmitting program which causes the computer to perform a process of reporting at least one of a direction and magnitude by which an inclination receiving apparatus should be moved, on the basis of the inclination information.

Each exemplary embodiment described above is the preferred exemplary embodiment of the present invention and the scope of the present invention is not limited to only the above-mentioned exemplary embodiment. A modified embodiment in which various changes in the configuration of each exemplary embodiment that can be understood by those skilled in the art are made without departing from the scope of the invention can be used.

A hardware configuration of each inclination receiving apparatus in the second to fifth exemplary embodiments and the peripheral apparatus mentioned above may be the same as the hardware configuration shown in FIG. 5 like the first exemplary embodiment.

The invention of the present application has been described above with reference to the exemplary embodiment. However, the present invention is not limited to the above-mentioned exemplary embodiment. Various changes in the configuration or details of the invention of the present application that can be understood by those skilled in the art can be made without departing from the scope of the invention.

This application claims priority from Japanese Patent Application No. 2011-043870 filed on Mar. 1, 2011, the disclosure of which is hereby incorporated by reference in its entirety.

### INDUSTRIAL APPLICABILITY

The inclination receiving apparatus, the inclination transmitting apparatus, and the inclination communicating system of the present invention can be applied to a portable terminal and a communication system which realize a content sharing technology.

### DESCRIPTION OF THE REFERENCE NUMERALS

30 inclination communicating system

100 inclination receiving apparatus

101 receiving unit

102 report unit

171 CPU

172 interface

173 memory

174 storage apparatus

175 input apparatus

176 output apparatus

177 bus

178 recording medium

200 inclination receiving apparatus

201 receiving unit

202 report unit

203 output unit

300 inclination receiving apparatus

301 receiving unit

303 output unit

311 data communication unit

312 sensor

313 generation unit

314 imaging unit

330 inclination transmitting apparatus

330a inclination transmitting apparatus

330b inclination transmitting apparatus

331 sensor

331a sensor

331b sensor

332 generation unit

333 transmission unit

341 data communication unit

342 output unit

343 imaging unit

344 report unit

350 server

351 session management unit

352 data communication unit

1. An inclination receiving apparatus which communicates a content with an inclination transmitting apparatus comprising:
receiving unit which receives inclination information indicating an inclination of said inclination transmitting apparatus and
report unit which reports at least one of a direction and magnitude by which said inclination receiving apparatus should be moved, on the basis of said inclination information.

2. The inclination receiving apparatus described in claim 1, wherein
said inclination information is information indicating a displacement of the inclination of said inclination transmitting apparatus in a predetermined time and
said report unit reports at least one of the direction and magnitude by which said inclination receiving apparatus should be moved, according to the displacement indicated by said inclination information.

3. The inclination receiving apparatus described in claim 1, wherein
said inclination information is information indicating the inclination of said inclination transmitting apparatus at a predetermined time and
said report unit reports at least one of the direction and magnitude by which said inclination receiving apparatus should be moved, according to the inclination indicated by said inclination information.

4. The inclination receiving apparatus described in any one of claim 1, wherein
the inclination receiving apparatus includes output unit which outputs the content and
said report unit reports at least one of the direction and magnitude by which said inclination receiving apparatus should be moved, when said output unit outputs the content.

5. The inclination receiving apparatus described in claim 4, wherein
said inclination information is information indicating the inclination of said inclination transmitting apparatus when the content communicated by said inclination transmitting apparatus is created.

6. The inclination receiving apparatus described in claim 4, wherein
said inclination information is information indicating the inclination of said inclination transmitting apparatus when the output unit of said inclination transmitting apparatus outputs the content that is indicated by said inclination transmitting apparatus and
said report unit reports at least one of the direction and magnitude by which said inclination receiving apparatus should be moved, when the output unit of said inclination receiving apparatus outputs said content.

7. An inclination transmitting apparatus comprising:
a sensor which detects an inclination of said inclination transmitting apparatus,
generation unit which generates inclination information indicating the inclination of said inclination transmitting apparatus based on said inclination, and
transmitting unit which transmits said inclination information to said inclination receiving apparatus which reports at least one of the direction and magnitude by which said inclination receiving apparatus should be moved, on the basis of said inclination information.

8. An inclination communicating system including
an inclination transmitting apparatus and an inclination receiving apparatus which communicate a content with each other and
a server which establishes a session between said inclination transmitting apparatus and said inclination receiving apparatus, wherein
said inclination transmitting apparatus comprises
a sensor which detects an inclination of said inclination transmitting apparatus,
generation unit which generates inclination information based on the inclination detected by said sensor, and
transmitting unit which transmits the inclination information generated by said generation unit to said inclination receiving apparatus via said server and
said inclination receiving apparatus comprises
receiving unit which receives said inclination information from said inclination transmitting apparatus via said server and
report unit which reports at least one of a direction and magnitude by which said inclination receiving apparatus should be moved, on the basis of said inclination information.

9. An inclination receiving method comprising the steps of:
receiving inclination information indicating an inclination of another apparatus and
reporting at least one of a direction and magnitude by which an inclination receiving apparatus should be moved, on the basis of said inclination information.

10. An inclination transmitting method comprising the steps of:
detecting an inclination of an inclination transmitting apparatus,
generating inclination information indicating the inclination of said inclination
transmitting apparatus based on said inclination, and transmitting said inclination information to an inclination receiving apparatus which reports at least one of a direction and magnitude by which said inclination receiving apparatus should be moved, on the basis of said inclination information.

11. An inclination communicating method comprising the steps of:
detecting an inclination of an inclination transmitting apparatus,
generating inclination information indicating the inclination of said inclination transmitting apparatus based on said inclination, and
reporting at least one of a direction and magnitude by which an inclination receiving apparatus should be moved, on the basis of said inclination information.

12. A non-transitory computer-readable recording medium having embodied thereon an inclination receiving program which causes a computer to perform
a process of communicating a content with another apparatus and receiving inclination information indicating an inclination of said another apparatus and
a process of reporting at least one of a direction and magnitude by which an inclination receiving apparatus should be moved, on the basis of said inclination information.

13. A non-transitory computer-readable recording medium having embodied thereon an inclination transmitting program which causes a computer to perform
a process of detecting an inclination of an inclination transmitting apparatus including the computer,
a process of generating inclination information indicating the inclination of said inclination transmitting apparatus based on said inclination, and
a process of reporting at least one of a direction and magnitude by which an inclination receiving apparatus should be moved, on the basis of said inclination information.

14. An inclination receiving apparatus which communicates a content with an inclination transmitting apparatus comprising:
receiving means for receiving inclination information indicating an inclination of said inclination transmitting apparatus and
report means for reporting at least one of a direction and magnitude by which said inclination receiving apparatus should be moved, on the basis of said inclination information.
